(19) United States
(12) Patent Application Publication
(10) Pub. No.: US 2003/0072916 A1
(43) Pub. Date: Apr. 17, 2003

(54) Molds for making protective corner strap for suitcase

(76) Inventor: Sheng Chin Chen, Da Gia Town (TW)

Correspondence Address: CHARLES E. BAXLEY, 59 John Street-5th Floor, New York, NY, 10038, US

(21) Appl. No.: 09/976,861

(22) Filed: Oct. 15, 2001

(51) Int. Cl. B32B 3/10

(52) U.S. Cl. 428/138

(57) ABSTRACT

A mold group for manufacturing a protective corner strap for a suitcase or the like, includes one or more rods engaged in a mold device for forming an inner layer and one or more studs or blocks on the rod, which is then engaged in another mold device, for forming an outer layer onto the inner layer and the studs or the blocks. The studs or the blocks may be extended outward or inward of the outer layer or may be flush with the outer layer for allowing the inner layer to be solidly secured in the outer layer, and may include various kinds of shapes for decorative purposes.

### BACKGROUND OF THE INVENTION

1. Field of the Invention

The present invention relates to a protective corner strap for a suitcase or the like, and more particularly to a method and/or a mold assembly for manufacturing the protective corner strap for the suitcase or the like.

2. Description of the Prior Art

Typical corner straps for suitcases are made of a single molded process or mold injection process and have a planer outer appearance that may be applied with various kinds of patterns thereon. The patterns may be easily disengaged from the planer outer appearance of the corner straps.

The present invention has arisen to mitigate and/or obviate the afore-described disadvantages of the conventional protective corner straps.

### SUMMARY OF THE INVENTION

The primary objective of the present invention is to provide a mold assembly for manufacturing a protective corner strap for a suitcase or the like.

The other objective of the present invention is to provide a method for manufacturing the protective corner strap for the suitcase or the like.

In accordance with one aspect of the invention, there is provided a mold assembly for manufacturing a protective corner strap for a suitcase or the like, the mold assembly comprising a first mold device including a first and a second mold members each having at least one conduit formed therein, and each having a peripheral recess and at least one cavity formed therein and communicating with the conduit thereof, an inner mold member including at least one rod for being engaged in the conduit of the first and the second mold members, the peripheral recess and the cavity of the first mold device being formed around the inner mold member for forming an inner layer and at least one stud on the rod, and a second mold device including a third and a fourth mold members each having at least one passage formed therein for receiving the rod and the inner layer therein, the passage of the second mold device including an inner diameter greater than an outer diameter of the inner layer for forming an outer layer onto the inner layer and for forming the protective corner strap.

A device is further provided for positioning the first and the second mold members together and includes at least one cavity formed in the first mold member, and at least one projection extended from the second mold member and engaged into the cavity of the first mold member for securing the first and the second mold members together.

The inner mold member includes at least one bulge extended therefrom for forming at least one depression in the inner layer and for allowing the inner layer to be solidly engaged onto the rod.

The first and the second mold members each includes at least one groove formed therein and communicating with the conduit thereof for forming a block on the inner layer.

The first mold device includes a passageway formed therein and communicating with the conduit of the first and the second mold members, for injecting a material into the conduit of the first and the second mold members.

The rod includes a portion engaged with the first mold device for forming a gap in the protective corner strap.

A device is further provided for positioning the third and the fourth mold members together and includes at least one cavity formed in the third mold member, and at least one projection extended from the fourth mold member and engaged into the cavity of the third mold member for securing the third and the fourth mold members together.

The second mold device includes a passageway formed therein and communicating with the passage of the third and the fourth mold members, for injecting a material into the passage of the third and the fourth mold members.

The second mold device includes a pair of slits formed therein and communicating with the passage of the third and the fourth mold members, for forming a pair of flaps on the corner strap.

The rod includes a portion engaged with the second mold device and engaged between the pair of slits of the second mold device for forming a gap in the protective corner strap.

In accordance with the other aspect of the invention, there is provided a method for manufacturing a protective corner strap, and comprising providing a first mold device, engaging at least one rod into the first mold device, forming an inner layer onto the rod, and forming at least one stud on the inner layer, providing a second mold device, engaging the rod and the inner layer into the second mold device, and forming an outer layer onto the inner layer, the outer layer including at least one orifice formed therein for receiving the stud of the inner layer.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a protective corner strap for a suitcase or the like to be manufactured with a mold assembly in accordance with the present invention;

FIG. 2 is a cross sectional view taken along lines 2-2 of FIG. 1;

FIGS. 3, 4 are cross sectional views taken along lines 3-3 and 4-4 of FIG. 2 respectively;

FIG. 5 is an exploded view illustrating a first mold device for forming a prototype or an inner layer of the protective corner strap for the suitcase or the like;

FIG. 6 is a perspective view showing the rear or inner portion of one of the mold members of the first mold device;

FIG. 7 is a cross sectional view of the first mold device;

FIG. 8 is an exploded view illustrating a second mold device for forming the protective corner strap for the suitcase or the like;

FIG. 9 is a perspective view showing the rear or inner portion of one of the mold members of the second mold device;

FIG. 10 is a cross sectional view of the second mold device; and

FIGS. 11 and 12 are perspective views illustrating the other two applications or arrangements of the protective corner strap for the suitcase or the like.

### DETAILED DESCRIPTION OF THE PREFERRED EMBODIMENT

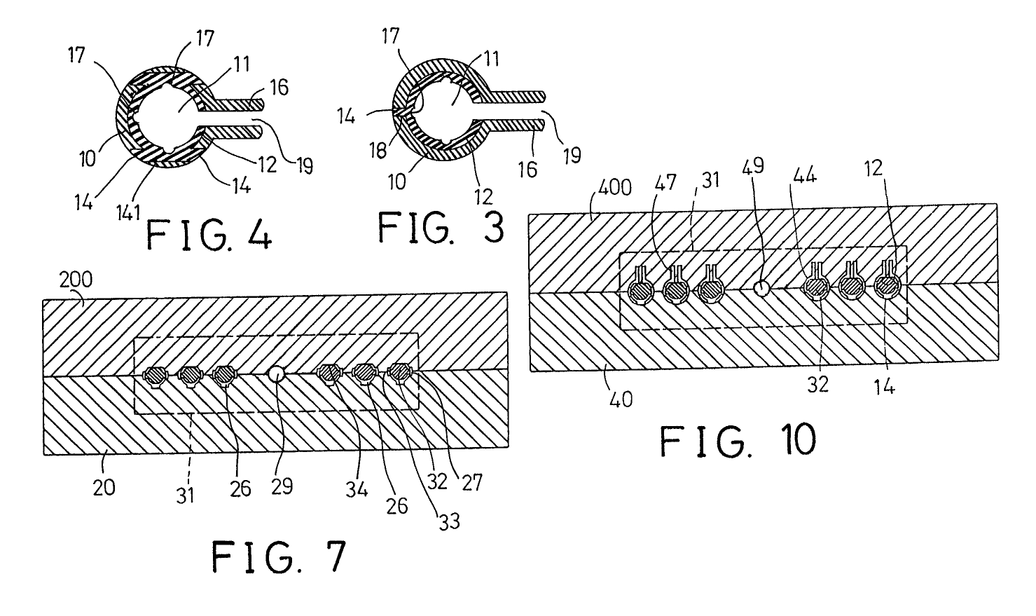

Referring to the drawings, and initially to FIGS. 1-4, illustrated is a protective corner strap for a suitcase or the like that is to be manufactured by a mold assembly and/or a method in accordance with the present invention. The protective corner strap comprises a longitudinal body 10 including a longitudinal hole 11 formed therein, and including a pair of parallel flaps 16 extended therefrom, and a gap 19 formed between the flaps 16. The longitudinal body 10 includes an inner layer 12 disposed or engaged in an outer layer 13 by a molding process to be described hereinafter. The inner layer 12 includes a number of projections or studs 14 extended outward therefrom and engaged through the orifices 18 of the outer layer 13.

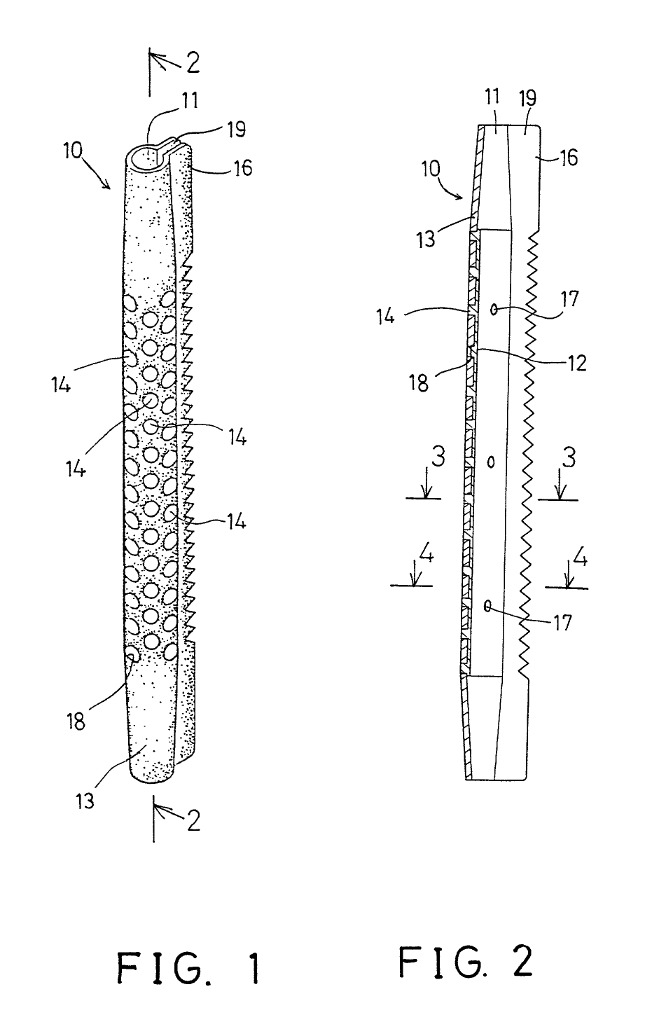

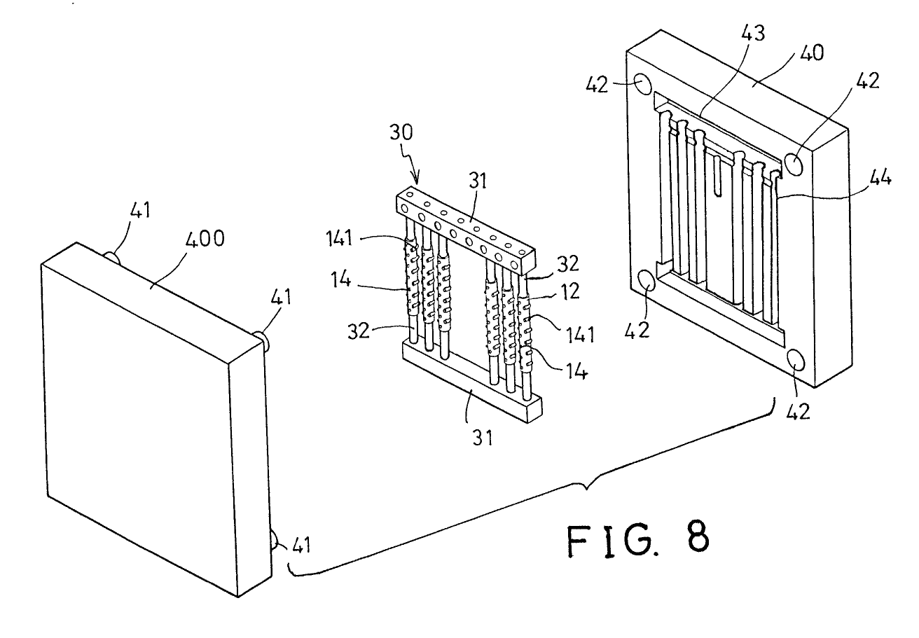

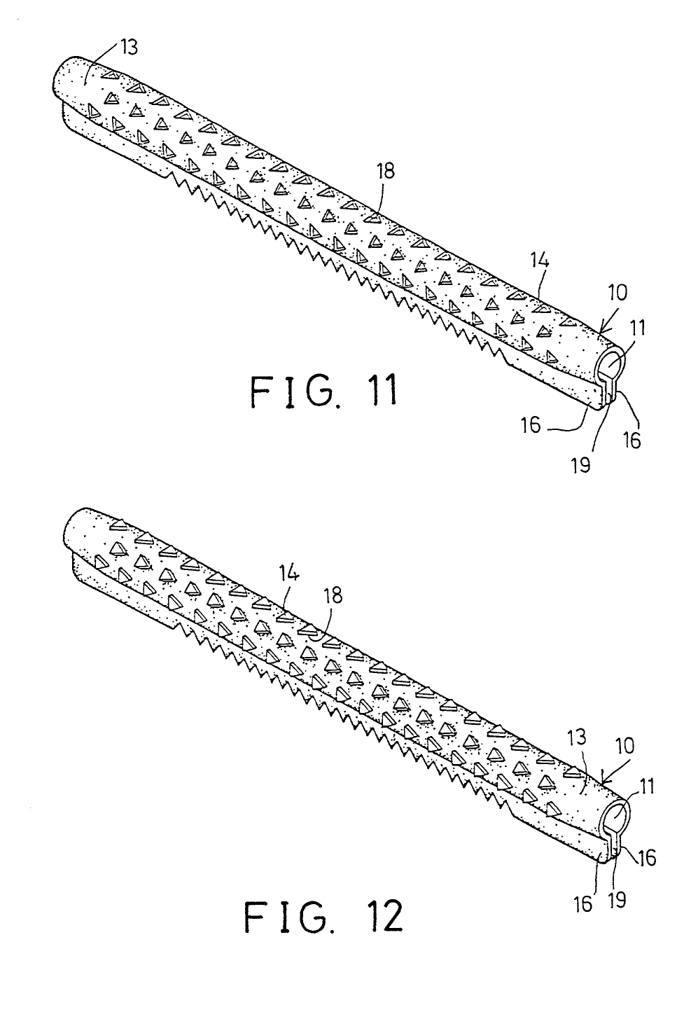

The studs 14 may be formed into various kinds of shapes or patterns for decorative purposes. For example, as shown in FIG. 1, the studs 14 may include a circular cross section. As shown in FIGS. 11, 12, the studs 14 may include a triangular cross section. Similarly, the studs 14 may also be formed into various kinds of shapes, such as the rectangular shape, the oval shape, or the animal or flower shapes, etc. The studs 14 may be flush with the outer layer 13 of the longitudinal body 10 (FIGS. 1, 2), or may be extended outward beyond the outer layer 13 (FIG. 12), or may be shorter or extended inward of the outer layer 13 (FIG. 11). As shown in FIGS. 4 and 8, some of the studs 14 may be connected together with blocks 141 for mold releasing purposes, for example.

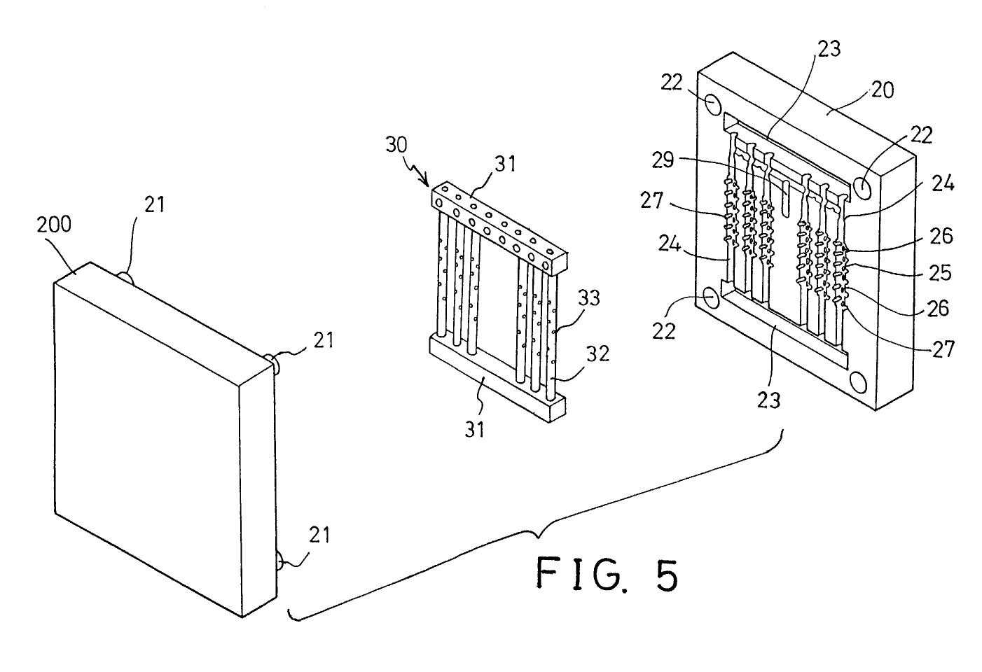

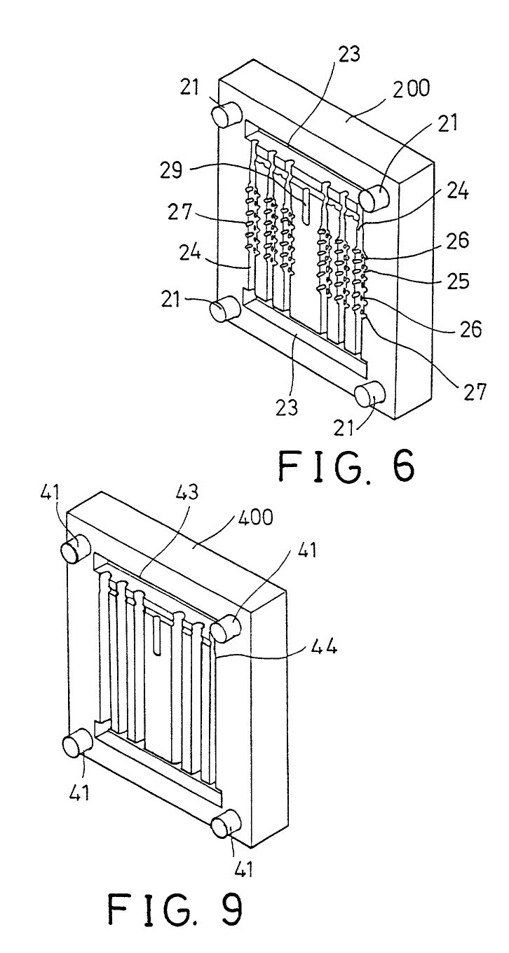

Referring next to FIGS. 5-7, a mold assembly includes a first mold device 20, 200 having a pair of opposite mold members 20, 200. The mold member 200 includes one or more projections 21 extended therefrom for engaging into the cavities 22 of the other mold member 20, and for securing the mold members 20, 200 together. The mold members 20, 200 each includes an upper and a lower recesses 23, and one or more conduits 24 formed between the recesses 23 thereof and communicating with the recesses 23 thereof. An inner mold member 30 includes a pair of bars 31 for engaging into the recesses 23 of the mold members 20, 200, and one or more rods 32 secured between the conduits 24 of the mold members 20, 200 for being solidly and stably engaged within the mold members 20, 200. The rods 32 each includes one or more bulges 33 extended outward therefrom, particularly extended radially outward therefrom.

The mold members 20, 200 each further includes one or more inner peripheral recesses 25 formed therein and communicating with the conduits 24 respectively and formed around the rods 32 respectively, for forming the inner layer 12 of the protective corner strap 10. The mold members 20, 200 each further includes one or more cavities 26 and one or more grooves 27 formed therein and communicating with the conduits 24 and the inner peripheral recesses 25 respectively for forming the studs 14 and/or the blocks 141 on the inner layer 12 of the protective corner strap 10 respectively. One or more passageways 29 are formed in either or both of the mold members 20, 200 and communicating with the conduits 24 for injecting the materials into the conduits 24 and the recesses 25 respectively, and for forming the inner layer 12 and the studs 14 and/or the blocks 141 on the inner layer 12.

As best shown in FIG. 7, the rods 32 each includes a portion 34, such as a flat surface or a flat portion 34 engaged with or contacted with the mold member 200, for forming the gap 19 within the body 10. The bulges 33 of the rods 32 may be engaged into the inner layer 12 for forming one or more depressions 17 (FIGS. 2-4) in the inner layer 12, and for allowing the inner layer 12 to be solidly engaged onto and retained on the rods 32 respectively (FIG. 8).

Referring next to FIGS. 8-10, after the inner layer 12 has been formed onto the rods 32 respectively, with the first mold device 20, 200 by a first molding process, the mold assembly further includes a second mold device 40, 400 having a pair of opposite mold members 40, 400. The mold member 400 includes one or more projections 41 extended therefrom for engaging into the cavities 42 of the other mold member 40, and for securing the mold members 40, 400 together. The mold members 40, 400 each also includes an upper and a lower recesses 43 formed therein, for receiving the bars 31 of the inner mold member 30 respectively.

The mold members 40, 400 each further includes one or more passages 44 formed therein and formed around the rods 32 and the inner layers 12 respectively, and having a shape corresponding to the longitudinal body 10 of the protective corner strap 10, and having an inner diameter greater than that of the inner layer 12 of the body 10, for forming the longitudinal body 10 of the protective corner strap 10. One or more passageways 49 are formed in either or both of the mold members 40, 400 and communicating with the passages 44 of the mold members 40, 400 for injecting the materials into the passages 44 and the recesses 45 respectively, and for forming the outer layer 13 of the longitudinal body 10.

As best shown in FIG. 10, the mold member 400 includes one or more pairs of slits 47 formed therein and communicating with the passages 44 thereof for forming the flaps 16 on the longitudinal body 10. The flat portions 34 of the rods 32 are engaged with or contacted with the mold member 400, and engaged between the slits 47 for forming the gap 19 within the body 10.

Alternatively, the mold members 40, 400 may each include one or more depressions formed therein for receiving the end or tip portions of the studs 14 or the blocks 141, and for allowing the studs 14 or the blocks 141 to be slightly extended outward of the outer layer 13 (FIG. 12) after the outer layer 13 is formed or molded onto the inner layer 12. Similarly, the mold members 40, 400 may each include one or more juts or bulges extended therefrom and engaged into the respective passages 44 of the mold members 40, 400, and engaged with the respectively studs 14 or the blocks 141, for allowing the studs 14 or the blocks 141 to be slightly extended inward of the outer layer 13 (FIG. 11) after the outer layer 13 is formed or molded onto the inner layer 12.

Accordingly, the mold assembly in accordance with the present invention may be used for forming an inner layer within an outer layer, and may be formed with one or more studs or blocks on the inner layer, for allowing the studs or blocks to be flush with or extended outward or extended inward of the outer layer of the protective corner strap.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mold assembly for manufacturing a protective corner strap for a suitcase or the like, said mold assembly comprising:
a first mold device including a first and a second mold members each having at least one conduit formed therein, and each having a peripheral recess and at least one cavity formed therein and communicating with said at least one conduit thereof,
an inner mold member including at least one rod for being engaged in said at least one conduit of said first and said second mold members, said peripheral recess and said at least one cavity of said first mold device being formed around said inner mold member for forming an inner layer and at least one stud on said rod, and
a second mold device including a third and a fourth mold members each having at least one passage formed therein for receiving said at least one rod and said inner layer therein, said at least one passage of said second mold device including an inner diameter greater than an outer diameter of said inner layer for forming an outer layer onto said inner layer and for forming the protective corner strap.

2. The mold assembly according to claim 1 further comprising means for positioning said first and said second mold members together.

3. The mold assembly according to claim 2, wherein said positioning means includes at least one cavity formed in said first mold member, and at least one projection extended from said second mold member and engaged into said at least one cavity of said first mold member for securing said first and said second mold members together.

4. The mold assembly according to claim 1, wherein said inner mold member includes at least one bulge extended therefrom for forming at least one depression in the inner layer and for allowing the inner layer to be solidly engaged onto said rod.

5. The mold assembly according to claim 1, wherein said first and said second mold members each includes at least one groove formed therein and communicating with said at least one conduit thereof for forming a block on the inner layer.

6. The mold assembly according to claim 1, wherein said first mold device includes a passageway formed therein and communicating with said at least one conduit of said first and said second mold members, for injecting a material into said at least one conduit of said first and said second mold members.

7. The mold assembly according to claim 1, wherein said at least one rod includes a portion engaged with said first mold device for forming a gap in the protective corner strap.

8. The mold assembly according to claim 1 further comprising means for positioning said third and said fourth mold members together.

9. The mold assembly according to claim 8, wherein said positioning means includes at least one cavity formed in said third mold member, and at least one projection extended from said fourth mold member and engaged into said at least one cavity of said third mold member for securing said third and said fourth mold members together.

10. The mold assembly according to claim 1, said said second mold device includes a passageway formed therein and communicating with said at least one passage of said third and said fourth mold members, for injecting a material into said at least one passage of said third and said fourth mold members.

11. The mold assembly according to claim 1, said said second mold device includes a pair of slits formed therein and communicating with said at least one passage of said third and said fourth mold members, for forming a pair of flaps on the corner strap.

12. The mold assembly according to claim 11, wherein said at least one rod includes a portion engaged with said second mold device and engaged between said pair of slits of said second mold device for forming a gap in the protective corner strap.

13. A method for manufacturing a protective corner strap for a suitcase or the like, said method comprising:
providing a first mold device, engaging at least one rod into said first mold device,
forming an inner layer onto said at least one rod, and forming at least one stud on said inner layer,
providing a second mold device,
engaging said at least one rod and said inner layer into said second mold device,
forming an outer layer onto said inner layer, said outer layer including at least one orifice formed therein for receiving said at least one stud of said inner layer.

14. The method according to claim 13 further comprising providing at least one bulge on said at least one rod for engaging into said inner layer and for solidly securing said inner layer on said at least one rod.

15. The method according to claim 13 further comprising providing at least one groove in said first mold device for forming at least one block on said inner layer.

16. The method according to claim 13 further comprising retaining said at least one rod in said first mold device.

17. The method according to claim 13 further comprising retaining said at least one rod and said inner layer in said second mold device.

18. A protective corner strap for a suitcase or the like, said protective corner strap comprising:
an elongate body including an outer layer having a plurality of orifices formed therein, and an inner layer engaged in said outer layer and having a plurality of studs extended therefrom and engaged into said orifices of said outer layer.

19. The protective corner strap according to claim 18, wherein said inner layer includes a plurality of blocks formed thereon, said blocks each includes two ends engaged in said orifices of said outer layer.
